(19) United States
(12) Patent Application Publication
(10) Pub. No.: US 2025/0367563 A1
(43) Pub. Date: Dec. 4, 2025

(54) INTERACTIVE 3D CONTENT GENERATION AND SHARING ON VIDEO GAME MEDIA GALLERIES

(71) Applicants: SONY GROUP CORPORATION, Tokyo (JP); Sony Corporation of America, New York, NY (US)

(72) Inventors: Alexandre Zaghetto, San Jose, CA (US); Danillo Graziosi, Flagstaff, AZ (US); Ali Tabatabai, Cupertino, CA (US)

(21) Appl. No.: 19/190,564

(22) Filed: Apr. 25, 2025

Related U.S. Application Data
(60) Provisional application No. 63/655,252, filed on Jun. 3, 2024.

(51) Int. Cl. A63F 13/86; G06T 15/20

(52) U.S. Cl. CPC A63F 13/86; G06T 15/205

(57) ABSTRACT

Generating and sharing interactive three dimensional (3D) content/3D models captured from gaming sessions are described herein. The 3D content is able to be shared with mobile devices, televisions, gaming consoles, Virtual Reality (VR) devices or other devices. Since the content is rendered in 3D, a user is able to change the view direction, zoom in/out, and perform other functions. A framework enables video game media galleries to capture, view, edit, and share interactive, static or dynamic 3D media while keeping the structure of the original gaming assets inaccessible to the end-user.

### CROSS-REFERENCE TO RELATED APPLICATION(S)

This application claims priority under 35 U.S.C. § 119(e) of the U.S. Provisional Patent Application Ser. No. 63/655,252, filed Jun. 3, 2024 and titled, “INTERACTIVE 3D CONTENT GENERATION AND SHARING ON VIDEO GAME MEDIA GALLERIES,” which is hereby incorporated by reference in its entirety for all purposes.

### FIELD OF THE INVENTION

The present invention relates to interactive 3D content. More specifically, the present invention relates to interactive 3D content generation and sharing.

### BACKGROUND OF THE INVENTION

A media gallery is a feature that allows users to view and manage their captured media. This includes screenshots, video clips, and other recorded content. The media gallery can provide various tools for organizing, editing, and sharing captured content. For instance, users can: access and view all saved screenshots and video clips; perform basic editing tasks, such as trimming video clips to highlight specific moments; share captured media directly to social media platforms; and manage and organize media files to ensure efficient use of storage.

Media galleries are common features in modern gaming ecosystems. They are integrated into various gaming platforms, consoles and apps, providing players with tools to capture, edit, and share their gameplay experiences. Here are some examples of the major gaming platforms: PlayStation (PS4 and PS5), X box (X box One and Xbox Series X/S), Nintendo (Switch), PC Gaming (Steam), and Mobile Gaming (iOS and Android).

These media galleries with capture features have become important aspects of the gaming experience, reflecting the growing importance of content creation and social sharing in the gaming community. They enhance the overall gaming experience by enabling players to easily showcase and share their favorite gaming moments.

Gaming media galleries currently provide tools for users to capture, view, edit and share their 2D screenshots and 2D videos clips recorded during gameplay sessions.

### SUMMARY OF THE INVENTION

Generating and sharing interactive three dimensional (3D) content/3D models captured from gaming sessions are described herein. The 3D content is able to be shared with mobile devices, televisions, gaming consoles, Virtual Reality (VR) devices or other devices. Since the content is rendered in 3D, a user is able to change the view direction, zoom in/out, and perform other functions. A framework enables video game media galleries to capture, view, edit, and share interactive, static or dynamic 3D media while keeping the structure of the original gaming assets inaccessible to the end-user.

In one aspect, a method programmed in a non-transitory memory of a device comprises capturing 2D content from a video game, generating 3D content from the 2D content and sharing the 3D content. The method further comprises extracting 2D frames from the 2D content. Wherein the 2D frames comprise a plurality of images of an object or a scene from a plurality of angles. The method further comprises encoding the 2D content, transmitting the encoded 2D content to a second device and decoding the encoded 2D content on the second device. The method further comprises implementing training data preparation, including reconstructing 3D structures from a series of 2D images taken from different perspectives. The method further comprises training a model using the trained data preparation. Generating the 3D content from the 2D content uses the trained model. Generating the 3D content utilizes point-based representations including Gaussian splats. The method further comprises displaying the 3D content including enabling interaction with the 3D content. The generated 3D content is static or dynamic.

In another aspect, an apparatus comprises a non-transitory memory for storing an application, the application for: capturing 2D content from a video game, generating 3D content from the 2D content and sharing the 3D content and a processor coupled to the memory, the processor for processing the application. The application is further for extracting 2D frames from the 2D content. The 2D frames comprise a plurality of images of an object or a scene from a plurality of angles. The application is further for: encoding the 2D content, transmitting the encoded 2D content to a second device and decoding the encoded 2D content on the second device. The application is further for implementing training data preparation, including reconstructing 3D structures from a series of 2D images taken from different perspectives. The application is further for training a model using the trained data preparation. Generating the 3D content from the 2D content uses the trained model. Generating the 3D content utilizes point-based representations including Gaussian splats. The application is further for displaying the 3D content including enabling interaction with the 3D content. The generated 3D content is static or dynamic.

In another aspect, a system comprises a user device configured for: capturing 2D content from a video game and transmitting the 2D content to a cloud device, the cloud device configured for: generating 3D content from the 2D content and sharing the 3D content. The cloud device is further configured for extracting 2D frames from the 2D content. The 2D frames comprise a plurality of images of an object or a scene from a plurality of angles. The user device is further configured for encoding the 2D content. The cloud device is further configured for implementing training data preparation, including reconstructing 3D structures from a series of 2D images taken from different perspectives. The cloud device is further configured for training a model using the trained data preparation. Generating the 3D content from the 2D content uses the trained model. Generating the 3D content utilizes point-based representations including Gaussian splats. The user device is further configured for displaying the 3D content including enabling interaction with the 3D content. The generated 3D content is static or dynamic.

### BRIEF DESCRIPTION OF THE DRAWINGS

FIG. 1 illustrates a flowchart of a method of interactive 3D content generation, editing, storing and sharing according to some embodiments.

FIG. 2 illustrates a diagram of content capture according to some embodiments.

FIG. 3 illustrates a diagram of 3D media generation according to some embodiments.

FIG. 4 illustrates a diagram of 3D media transmission according to some embodiments.

FIG. 5 illustrates a diagram of a framework for interactive 3D content generation and sharing according to some embodiments.

FIG. 6 illustrates a diagram of a framework for interactive 3D content generation and sharing according to some embodiments.

FIG. 7 illustrates a diagram of a framework for interactive 3D content generation and sharing according to some embodiments.

FIG. 8 shows a block diagram of an exemplary computing device configured to implement the interactive 3D content system according to some embodiments.

FIG. 9 shows a diagram of an exemplary interactive 3D content system according to some embodiments.

### DETAILED DESCRIPTION OF THE PREFERRED EMBODIMENT

Described herein is an implementation for sharing interactive three dimensional (3D) content/3D models captured from gaming sessions. The 3D content is able to be shared with mobile devices, televisions, gaming consoles, Virtual Reality (VR) devices or other devices. Since the content is rendered in 3D, a user is able to change the view direction, zoom in/out, and perform other functions. A framework enables video game media galleries to capture, view, edit, and share interactive, static or dynamic 3D media while keeping the structure of the original gaming assets inaccessible to the end-user.

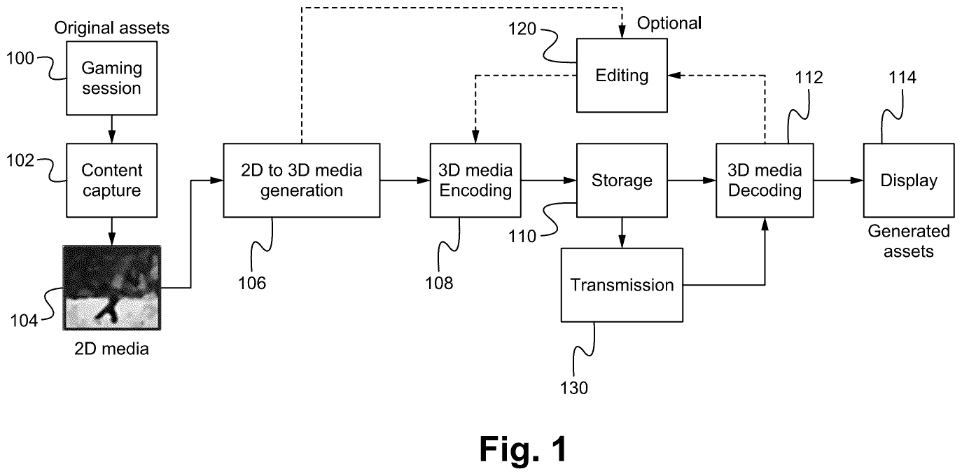

FIG. 1 illustrates a flowchart of a method of interactive 3D content generation, editing, storing and sharing according to some embodiments. In the step 100, a gaming session is in progress. For example, a user is playing a video game on a gaming console.

In the step 102, content is captured. 2D clips/images 104 of the gaming session are recorded. There are many ways of capturing the content. For example, the user is able to manually take pictures of a scene through the gaming console by pausing the game and taking 2D pictures of a scene or an object from different angles. In another example, a user is able to select a scene or an object, and a 3D image is automatically acquired by the system (e.g., application/console).

In the step 106, the 2D content is converted into 3D content using, but not limited to, point-based representations (e.g. Gaussian Splats, where the scene is represented as a collection of points, each associated with attributes such as position, color, and Gaussian parameters) or an implicit representation (e.g. Neural Radiance Fields (NeR Fs), which encode the entire scene implicitly within the weights of the neural network, allowing for high-quality rendering from novel viewpoints). These approaches are designed to generate novel views of a scene from a set of input images. They aim to synthesize realistic images from perspectives not originally captured in the input dataset. Both approaches leverage machine learning techniques to achieve their goals.

In the step 108, the generated 3D content is encoded using a 3D media encoder. The encoded 3D media is stored in the media gallery, in the step 110. The generated 3D content is able to be static or dynamic such that the 3D capture is able to represent one single instant in type or an interactive 3D video.

To visualize or edit the 3D content, the 3D content is decoded using a 3D media decoder, in the step 112. The decoded 3D content is then able to be displayed on the device screen, in the step 114. The 3D content is able to be edited, in the step 120, using any 3D content editing tool. The edited content is then able to be encoded.

The 3D content can also be transmitted, in the step 130, to another device, such as a smartphone, a computer, or a gaming console, for instance, where the 3D content can be decoded and rendered on a 2D screen (TV, smartphone, or monitor, for example), VR device, or any device equipped with the capability of decoding and displaying the transmitted content.

Another important aspect is that the generated 3D content keeps the possibility of interaction with the content, enabling the visualization of the scene or object from any synthesizable viewpoint.

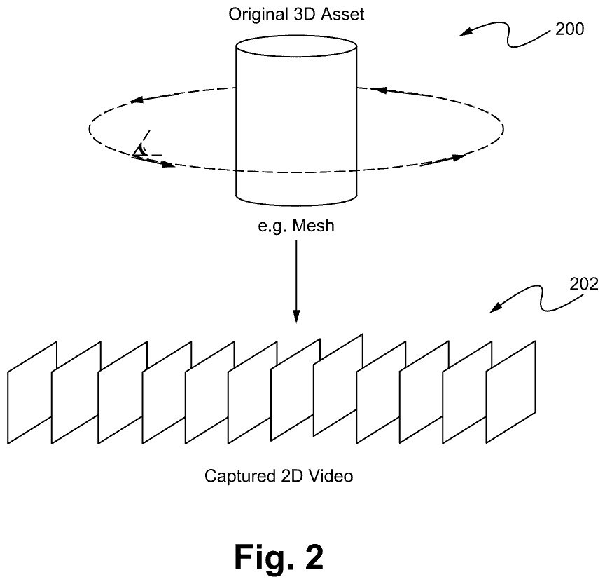

FIG. 2 illustrates a diagram of content capture according to some embodiments. In the example, a user is playing a video game with a dinosaur as an asset 200 (e.g., a mesh) in the game. The user pauses the game, and the user selects (e.g., by pressing record or capture) to capture a 3D asset of the dinosaur. The system automatically uses a virtual camera to capture a 2D video 202 of the dinosaur or scene with various viewpoints for the 3D representation. For example, 12 different images of the dinosaur are captured from various angles (e.g., front, left side, right side, back, top, bottom, front-left, bottom-right, and so on) by the virtual camera.

Variations of the asset capture are possible. For example, the asset is able to be captured during gameplay without pausing the game. The implementation to capture the asset is able to be by controller, mouse, joystick or another device. In some embodiments, a user's voice is used to capture an asset. For example, the user is able to say, “capture” or “capture scene,” and the system will capture the asset(s) or scene on the screen. In some embodiments, the system utilizes Artificial Intelligence (AI) or another implementation to recognize a user's command. For example, the user says, “capture dinosaur,” and although other assets may be on the screen, the system only captures the dinosaur asset. In addition to capturing an asset, the surrounding landscape is able to be captured.

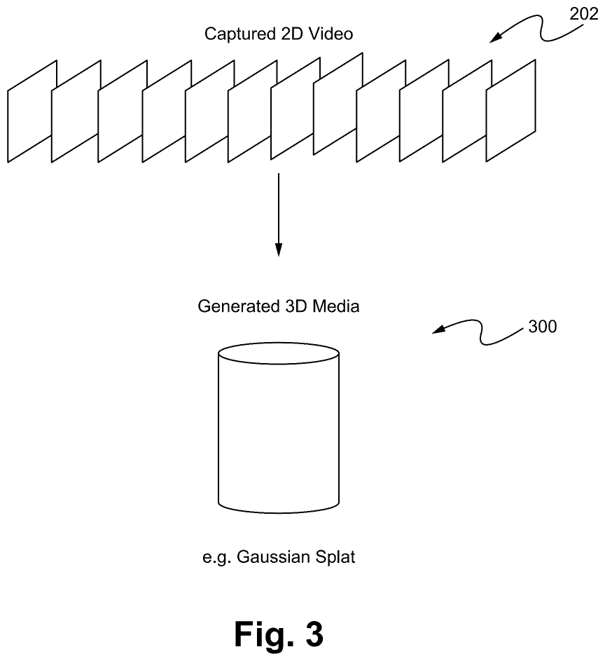

FIG. 3 illustrates a diagram of 3D media generation according to some embodiments. The captured 2D video 202 is converted into generated 3D content 300 (e.g., a Gaussian splat or any other 3D format), using but not limited to, a point-based representation or an implicit representation.

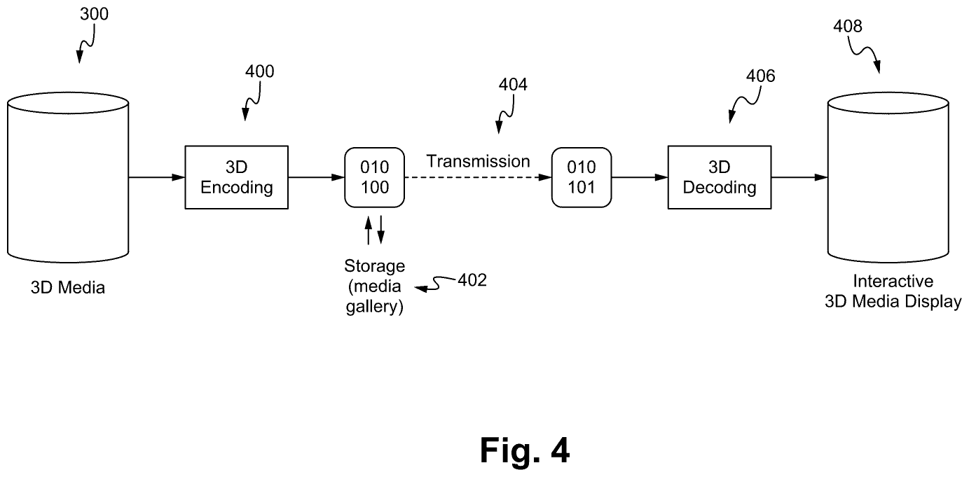

FIG. 4 illustrates a diagram of 3D media transmission according to some embodiments. The generated 3D content 300 is encoded using a 3D media encoder to generate encoded 3D content, in the step 400, and is stored in the media gallery, in the step 402. To visualize or edit the 3D content 300, the encoded 3D content is decoded using a 3D media decoder, in the step 406. The 3D content can also be transmitted to a remote device, such as a smartphone, a computer or a gaming console, in the step 404, where the 3D content can be decoded and rendered to a 2D screen (TV, smartphone or a monitor, for instance), VR device, or any device equipped with the capability of decoding or displaying the transmitted content, in the step 408.

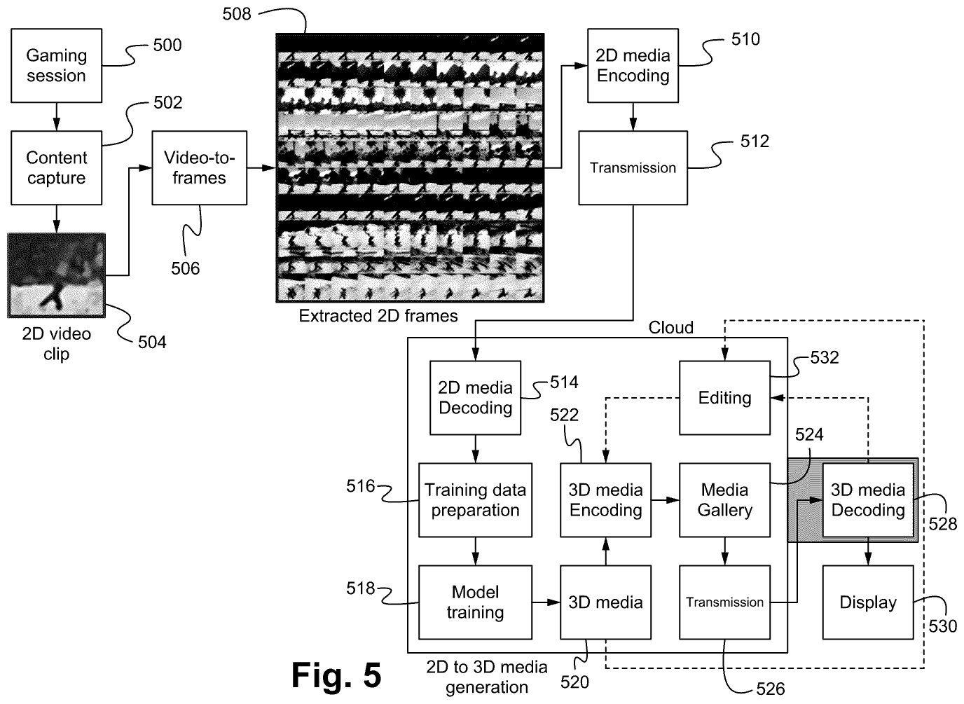

FIG. 5 illustrates a diagram of a framework for interactive 3D content generation and sharing according to some embodiments. In the step 500, a gaming session is in progress. For example, a user is playing a video game on a gaming console (e.g., a PS5).

In the step 502, 2D content (e.g., video clip) is captured. For example, 2D video clips 504 of the gaming session are recorded. In some embodiments, the system automatically captures a 2D video of an object or scene with the viewpoints for the later 3D representation. Alternatively, users can manually add or perform custom camera paths or individual screenshots. The input is the gameplay data, and the output is a video clip.

In the step 506, 2D frames are extracted from the video clips 504. Extracting the 2D frames is able to be implemented in any manner such as saving each image of a video clip. The system samples frames from the original video at the pre-defined frame rate. In some embodiments, FFmpeg is used to extract the frames. The extracted frames are saved as image files. Image 508 shows the extracted 2D frames.

In the step 510, the 2D content is encoded using any image or video encoder (e.g., a JPEG, HEVC encoder). In the step 512, the encoded 2D content is transmitted to a cloud device. In the step 514, the 2D content is decoded using any decoder (e.g., a JPEG, HEVC decoder).

In the step 516, training data preparation occurs. 3D structures are reconstructed from a series of 2D images taken from different perspectives. One example is the Structure-from-Motion (SfM) technique using COLMAP, which includes feature extraction, feature matching, camera pose estimation, sparse point cloud reconstruction and bundle adjustment.

In the step 518, a model is trained using the training data preparation. The model training is able to be supervised or unsupervised training. 2D images and training data are used to train the 3D equivalent content representation model (e.g., Gaussian splatting). Gaussian splatting allows for efficient and high-quality rendering of complex scenes. Training of Gaussian splatting is important to optimize the parameters of the Gaussian functions used to represent the scene or object accurately.

In the step 520, 3D content is generated from the 2D content using the trained model. The 2D content is converted into 3D content using, but not limited to, point-based representations (e.g. Gaussian Splats, where the scene is represented as a collection of points, each associated with attributes such as position, color, and Gaussian parameters) or an implicit representation (e.g. NeR Fs, which encode the entire scene implicitly within the weights of the neural network, allowing for high-quality rendering from novel viewpoints).

In the step 522, the 3D content is encoded using any 3D media encoder. In the step 524, the encoded 3D content is stored in a media gallery (e.g., PlayStation Media Gallery). In the step 526, the encoded 3D content is transmitted to another device. The PlayStation Media Gallery or PlayStation App is able to be used to transmit the 3D content to another device. The device is able to be the original device (e.g., gaming console, personal computer, mobile phone, VR headset) or another device (e.g., a different gaming console, personal computer, mobile phone, VR headset). In the step 528, the 3D content is decoded using any 3D media decoder. The 3D content is able to be decoded on the cloud device or another device.

In the step 530, the decoded 3D content is then displayed on the device (e.g., gaming console, personal computer, mobile phone, VR headset). Visualization can be performed on the gaming console/TV, Smartphone/A pp, VR glasses, PC or any other device or platform (e.g., social media) capable of decoding/rendering/displaying the 3D content.

In some embodiments, the decoded 3D content is able to be edited using 3D editing tools, in the step 532. The 3D editing tools are able to be on the cloud device or a user device.

In an example, the steps 514 through 526 and 532 are implemented on a cloud device, while the other steps are implemented on one or more user devices.

Although the framework describes separate devices performing various steps, the framework is able to be implemented in any manner on any number of devices. For example, the framework is able to be implemented on a single device, two devices or more devices, depending on the implementation. For example, in some embodiments, all of the steps are implemented on a user device. In another example, all of the steps are implemented on a server/cloud device with no input or minimal input from a user device (e.g., only a capture selection and displaying the 3D content).

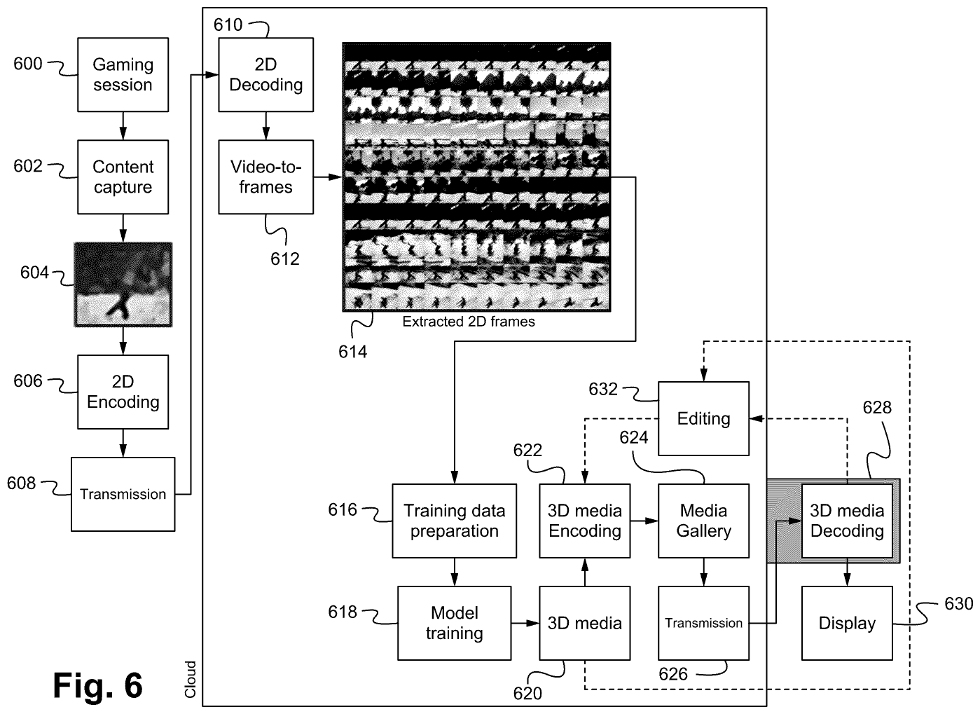

FIG. 6 illustrates a diagram of a framework for interactive 3D content generation and sharing according to some embodiments. The framework of FIG. 6 is similar to the framework of FIG. 5. A main difference between the two is that more steps (e.g., frame extraction) are performed in the cloud in the framework in FIG. 6.

In the step 600, a gaming session is in progress. For example, a user is playing a video game on a gaming console (e.g., a PS5).

In the step 602, 2D content (e.g., video clip) is captured. For example, 2D video clips 604 of the gaming session are recorded. In some embodiments, the system automatically captures a 2D video of an object or scene with the viewpoints for the later 3D representation. Alternatively, users can manually add or perform custom camera paths or individual screenshots. The input is the gameplay data, and the output is a video clip.

In the step 606, the 2D content is encoded using any video encoder (e.g., an HEVC encoder). In the step 608, the encoded 2D content is transmitted to a cloud device.

In the step 610, the 2D content is decoded using any video decoder (e.g., an HEVC decoder).

In the step 612, 2D frames are extracted from the video clips 604. Extracting the 2D frames is able to be implemented in any manner such as saving frames of a video clip. The system samples frames from the original video at the pre-defined frame rate. In some embodiments, FFmpeg is used to extract the frames. The extracted frames are saved as image files. Image 614 shows the extracted 2D frames.

In the step 616, training data preparation occurs. 3D structures are reconstructed from a series of 2D images taken from different perspectives. One example is the Structure-from-Motion (SfM) technique using COLMAP, which includes feature extraction, feature matching, camera pose estimation, sparse point cloud reconstruction and bundle adjustment.

In the step 618, a model is trained using the training data preparation. Training data, including 2D images, are used to train the 3D equivalent content representation model (e.g., Gaussian splatting). Gaussian splatting allows for efficient and high-quality rendering of complex scenes. Training of Gaussian splatting is important to optimize the parameters of the Gaussian functions used to represent the scene or object accurately.

In the step 620, 3D content is generated from the 2D content using the trained model. The 2D content is converted into 3D content using, but not limited to, point-based representations (e.g. Gaussian Splats, where the scene is represented as a collection of points, each associated with attributes such as position, color, and Gaussian parameters) or an implicit representation (e.g. NeR Fs, which encode the entire scene implicitly within the weights of the neural network, allowing for high-quality rendering from novel viewpoints).

In the step 622, the 3D content is encoded using any 3D media encoder. In the step 624, the encoded 3D content is stored in a media gallery (e.g., PlayStation Media Gallery). In the step 626, the encoded 3D content is transmitted to another device. The PlayStation Media Gallery or PlayStation App is able to be used to transmit the 3D content to another device. The device is able to be the original device (e.g., gaming console, personal computer, mobile phone, VR headset) or another device (e.g., a different gaming console, personal computer, mobile phone, VR headset). In the step 628, the 3D content is decoded using any 3D media decoder. The 3D content is able to be decoded on the cloud device or another device.

In the step 630, the decoded 3D content is then displayed on the device (e.g., gaming console, personal computer, mobile phone, VR headset). Visualization can be performed on the gaming console/TV, Smartphone/App, VR glasses, PC or any other device or platform (e.g., social media) capable of decoding/rendering/displaying the 3D content.

In some embodiments, the decoded 3D content is able to be edited using 2D or 3D editing tools, in the step 632. The 3D editing tools are able to be on the cloud device or a user device.

In an example, the steps 610 through 626 and 632 are implemented on a cloud device, while the other steps are implemented on one or more user devices.

Although the framework describes separate devices performing various steps, the framework is able to be implemented in any manner on any number of devices. For example, the framework is able to be implemented on a single device, two devices or more devices, depending on the implementation. For example, in some embodiments, all of the steps are implemented on a user device. In another example, all of the steps are implemented on a server/cloud device with no input or minimal input from a user device (e.g., only a capture selection and displaying the 3D content).

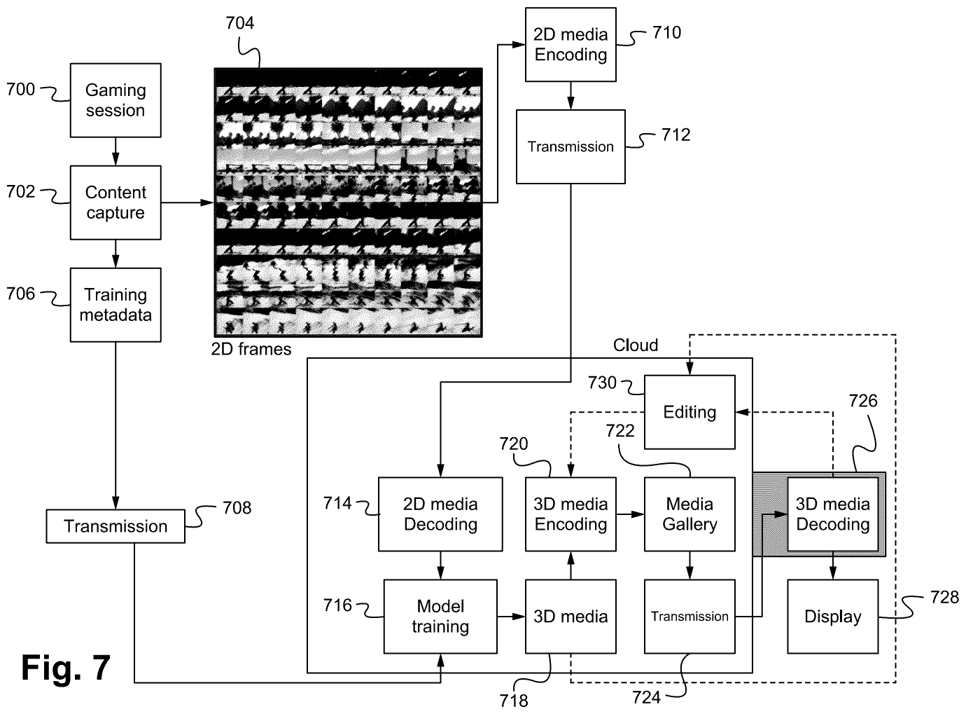

FIG. 7 illustrates a diagram of a framework for interactive 3D content generation and sharing according to some embodiments. The difference between FIGS. 5 and 6 compared to FIG. 7 is that in FIGS. 5 and 6, the user is capturing the video and estimating the metadata, such as camera poses and sparse 3D reconstruction, used to train the 3D model. However, in FIG. 7, since the rendering system has access to the game assets, it can, in addition to the rendered 2D images, directly provide the camera positions and the sparse 3D reconstruction.

In the step 700, a gaming session is in progress. For example, a user is playing a video game on a gaming console (e.g., a PS5).

In the step 702, 2D content is captured. In some embodiments, the system automatically captures multiple 2D images 704 of an object or scene to generate sufficient views for 3D representation. Users can also manually add or perform custom camera paths or individual screenshots. The input is the gameplay data, and the output includes 2D images captured from original assets and additional metadata 706 used to train the 3D model. 2D images are generated directly from the original game meshes. In this case, camera poses are known. Sparse point clouds can also be directly generated.

In the step 708, the training metadata 706 are transmitted to a cloud device.

In the step 710, the 2D images 704 are encoded using any encoder (e.g., a JPEG encoder). In the step 712, the encoded 2D images are transmitted to a cloud device. In the step 714, the 2D images 704 are decoded using any decoder (e.g., a JPEG decoder).

In the step 716, the 2D images 704, sparse point clouds and camera pose information are used to train the 3D representation of the object or scene. The sparse point clouds and camera pose information are known information.

Video-to-frames and training data preparation (e.g. SfM) are not utilized in this framework, since the data and metadata provided by these two steps can be directly obtained during the capture stage.

In the step 718, 3D content is generated from the 2D images using the trained model. The 2D images is converted into 3D content using, but not limited to, point-based representations (e.g. Gaussian Splats, where the scene is represented as a collection of points, each associated with attributes such as position, color, and Gaussian parameters) or an implicit representation (e.g. NeR Fs, which encode the entire scene implicitly within the weights of the neural network, allowing for high-quality rendering from novel viewpoints).

In the step 720, the 3D content is encoded using any 3D media encoder. In the step 722, the encoded 3D content is stored in a media gallery (e.g., PlayStation Media Gallery). In the step 724, the encoded 3D content is transmitted to another device. The PlayStation Media Gallery or PlayStation App is able to be used to transmit the 3D content to another device. The device is able to be the original device (e.g., gaming console, personal computer, mobile phone, VR headset) or another device (e.g., a different gaming console, personal computer, mobile phone, VR headset). In the step 726, the 3D content is decoded using any 3D media decoder. The 3D content is able to be decoded on the cloud device or another device.

In the step 728, the decoded 3D content is then displayed on the device (e.g., gaming console, personal computer, mobile phone, VR headset). Visualization can be performed on the gaming console/TV, Smartphone/App, VR glasses, PC or any other device or platform (e.g., social media) capable of decoding/rendering/displaying the 3D content.

In some embodiments, the decoded 3D content is able to be edited using 2D and 3D editing tools, in the step 730. The 3D editing tools are able to be on the cloud device or a user device.

In an example, the steps 714 through 724 and 730 are implemented on a cloud device, while the other steps are implemented on one or more user devices.

Although the framework describes separate devices performing various steps, the framework is able to be implemented in any manner on any number of devices. For example, the framework is able to be implemented on a single device, two devices or more devices, depending on the implementation. For example, in some embodiments, all of the steps are implemented on a user device. In another example, all of the steps are implemented on a server/cloud device with no input or minimal input from a user device (e.g., only a capture selection and displaying the 3D content).

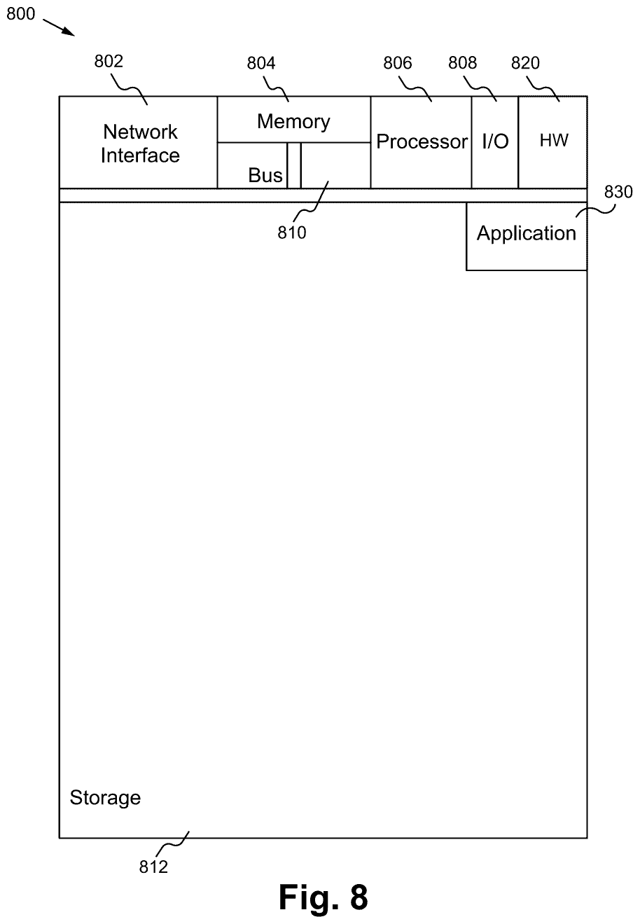

FIG. 8 shows a block diagram of an exemplary computing device configured to implement the interactive 3D content system according to some embodiments. The computing device 800 is able to be used to acquire, store, compute, process, communicate and/or display information such as images and videos. The computing device 800 is able to implement any of the interactive 3D content aspects. In general, a hardware structure suitable for implementing the computing device 800 includes a network interface 802, a memory 804, a processor 806, 1/0 device(s) 808, a bus 810 and a storage device 812. The choice of processor is not critical as long as a suitable processor with sufficient speed is chosen. The memory 804 is able to be any conventional computer memory known in the art. The storage device 812 is able to include a hard drive, CDROM, CDRW, DVD, DVDRW, High Definition disc/drive, ultra-HD drive, flash memory card or any other storage device. The computing device 800 is able to include one or more network interfaces 802. An example of a network interface includes a network card connected to an Ethernet or other type of LAN. The I/O device(s) 808 are able to include one or more of the following: keyboard, mouse, monitor, screen, printer, modem, touchscreen, button interface and other devices. Interactive 3D content application(s) 830 used to implement the interactive 3D content system are likely to be stored in the storage device 812 and memory 804 and processed as applications are typically processed. M ore or fewer components shown in FIG. 8 are able to be included in the computing device 800. In some embodiments, interactive 3D content hardware 820 is included. Although the computing device 800 in FIG. 8 includes applications 830 and hardware 820 for the interactive 3D content system, the interactive 3D content system is able to be implemented on a computing device in hardware, firmware, software or any combination thereof. For example, in some embodiments, the interactive 3D content applications 830 are programmed in a memory and executed using a processor. In another example, in some embodiments, the interactive 3D content hardware 820 is programmed hardware logic including gates specifically designed to implement the interactive 3D content system.

In some embodiments, the interactive 3D content application(s) 830 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

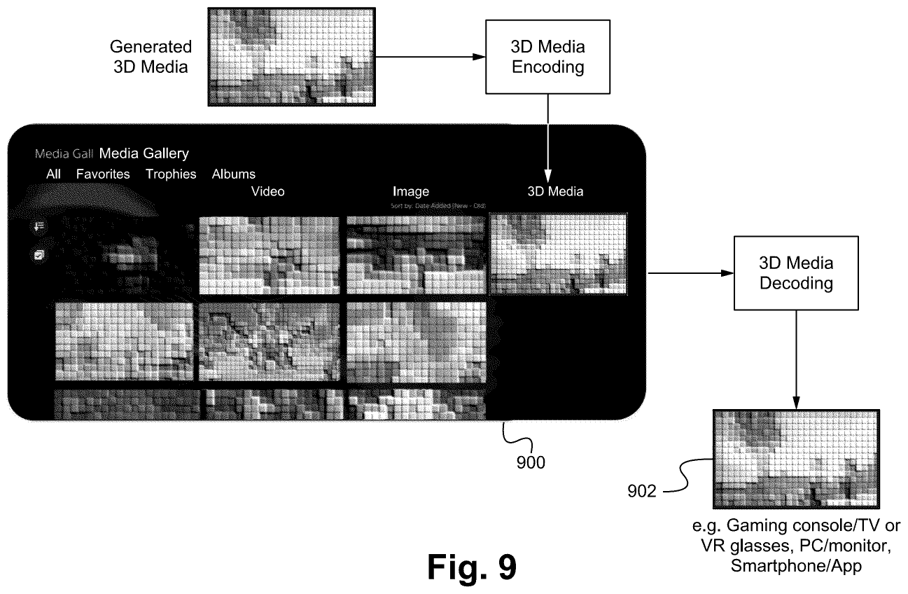

FIG. 9 shows a diagram of an exemplary interactive 3D content system according to some embodiments. As described herein, the interactive 3D content system is able to be implemented locally on one or more user devices, remotely on a Cloud device or a combination thereof. For example, the interactive 3D content system is implemented on a user device 900 (e.g., a gaming console, a mobile phone, a VR headset, a television). In another example, the interactive 3D content system is implemented on a cloud device by receiving input and/or content/media from the user device 900. In another example, aspects of the interactive 3D content system are implemented on the user device 900, and aspects of the interactive 3D content system are implemented on the cloud device. A second user device 904 (e.g., television, VR headset, a mobile device, a gaming console) is able to receive the 3D content. A ny aspect of the interactive 3D content system is able to be implemented on any device.

To utilize the interactive 3D content system and method described herein, devices such as a gaming console are used to acquire content. The interactive 3D content is able to be implemented with user involvement or automatically without user involvement.

In operation, the interactive 3D content system allows for capturing and sharing interactive static and dynamic 3D content/media. The interactive 3D content system also provides the possibility of interaction with the generated content. High quality rendering can be performed in real-time from any viewpoint requested by the user. In addition to 2D displays, the content can also be visualized using Virtual Reality devices. The way the 3D representation is generated, original game assets are protected by mapping the original game meshes into an alternative and irreversible representation that visually approximates the original data, but structurally does not resemble in any aspect the original data.

### SOME EMBODIMENTS OF INTERACTIVE 3D CONTENT GENERATION AND SHARING ON VIDEO GAME MEDIA GALLERIES

1. A method programmed in a non-transitory memory of a device comprising:
capturing 2D content from a video game; generating 3D content from the 2D content; and
sharing the 3D content.
   2. The method of clause 1 further comprising extracting 2D frames from the 2D content.
   3. The method of clause 2 wherein the 2D frames comprise a plurality of images of an object or a scene from a plurality of angles.
   4. The method of clause 1 further comprising:
encoding the 2D content;
transmitting the encoded 2D content to a second device; and
decoding the encoded 2D content on the second device.
   5. The method of clause 1 further comprising implementing training data preparation, including reconstructing 3D structures from a series of 2D images taken from different perspectives.
   6. The method of clause 5 further comprising training a model using the trained data preparation.
   7. The method of clause 6 wherein generating the 3D content from the 2D content uses the trained model.
   8. The method of clause 7 wherein generating the 3D content uti lizes point-based representations including Gaussian splats.
   9. The method of clause 1 further comprising displaying the 3D content including enabling interaction with the 3D content.
   10. The method of clause 1 wherein the generated 3D content is static.
   11. The method of clause 1 wherein the generated 3D content is dynamic.
   12. An apparatus comprising:
a non-transitory memory for storing an application, the application for:
   capturing 2D content from a video game;
   generating 3D content from the 2D content; and
   sharing the 3D content; and
a processor coupled to the memory, the processor for processing the application.
   13. The apparatus of clause 12 wherein the application is further for extracting 2D frames from the 2D content.
   14. The apparatus of clause 13 wherein the 2D frames comprise a plurality of images of an object or a scene from a plurality of angles.
   15. The apparatus of clause 12 wherein the application is further for:
encoding the 2D content;
transmitting the encoded 2D content to a second device; and
decoding the encoded 2D content on the second device.
   16. The apparatus of clause 12 wherein the application is further for implementing training data preparation, including reconstructing 3D structures from a series of 2D images taken from different perspectives.
   17. The apparatus of clause 16 wherein the application is further for training a model using the trained data preparation.
   18. The apparatus of clause 17 wherein generating the 3D content from the 2D content uses the trained model.
   19. The apparatus of clause 18 wherein generating the 3D content utilizes point-based representations including Gaussian splats.
   20. The apparatus of clause 12 wherein the application is further for displaying the 3D content including enabling interaction with the 3D content.
   21. The apparatus of clause 12 wherein the generated 3D content is static.
   22. The apparatus of clause 10 wherein the generated 3D content is dynamic.
   23. A system comprising:
a user device configured for:
   capturing 2D content from a video game; and
   transmitting the 2D content to a cloud device;
the cloud device configured for:
   generating 3D content from the 2D content; and
   sharing the 3D content.
      24. The system of clause 23 wherein the cloud device is further configured for extracting 2D frames from the 2D content.
      25. The system of clause 24 wherein the 2D frames comprise a plurality of images of an object or a scene from a plurality of angles.
      26. The system of clause 23 wherein the user device is further configured for encoding the 2D content.
      27. The system of clause 23 wherein the cloud device is further configured for implementing training data preparation, including reconstructing 3D structures from a series of 2D images taken from different perspectives.
      28. The system of clause 27 wherein the cloud device is further configured for training a model using the trained data preparation.
      29. The system of clause 28 wherein generating the 3D content from the 2D content uses the trained model.
      30. The system of clause 29 wherein generating the 3D content utilizes point-based representations including Gaussian splats.
      31. The system of clause 23 wherein the user device is further configured for displaying the 3D content including enabling interaction with the 3D content.
      32. The system of clause 23 wherein the generated 3D content is static.
      33. The system of clause 23 wherein the generated 3D content is dynamic.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
capturing 2D content from a video game;
generating 3D content from the 2D content; and
sharing the 3D content.

2. The method of claim 1 further comprising extracting 2D frames from the 2D content.

3. The method of claim 2 wherein the 2D frames comprise a plurality of images of an object or a scene from a plurality of angles.

4. The method of claim 1 further comprising:
encoding the 2D content;
transmitting the encoded 2D content to a second device; and
decoding the encoded 2D content on the second device.

5. The method of claim 1 further comprising implementing training data preparation, including reconstructing 3D structures from a series of 2D images taken from different perspectives.

6. The method of claim 5 further comprising training a model using the trained data preparation.

7. The method of claim 6 wherein generating the 3D content from the 2D content uses the trained model.

8. The method of claim 7 wherein generating the 3D content utilizes point-based representations including Gaussian splats.

9. The method of claim 1 further comprising displaying the 3D content including enabling interaction with the 3D content.

10. The method of claim 1 wherein the generated 3D content is static.

11. The method of claim 1 wherein the generated 3D content is dynamic.

12. An apparatus comprising:
a non-transitory memory for storing an application, the application for:
capturing 2D content from a video game;
generating 3D content from the 2D content; and
sharing the 3D content; and
a processor coupled to the memory, the processor for processing the application.

13. The apparatus of claim 12 wherein the application is further for extracting 2D frames from the 2D content.

14. The apparatus of claim 13 wherein the 2D frames comprise a plurality of images of an object or a scene from a plurality of angles.

15. The apparatus of claim 12 wherein the application is further for:
encoding the 2D content;
transmitting the encoded 2D content to a second device; and
decoding the encoded 2D content on the second device.

16. The apparatus of claim 12 wherein the application is further for implementing training data preparation, including reconstructing 3D structures from a series of 2D images taken from different perspectives.

17. The apparatus of claim 16 wherein the application is further for training a model using the trained data preparation.

18. The apparatus of claim 17 wherein generating the 3D content from the 2D content uses the trained model.

19. The apparatus of claim 18 wherein generating the 3D content utilizes point-based representations including Gaussian splats.

20. The apparatus of claim 12 wherein the application is further for displaying the 3D content including enabling interaction with the 3D content.

21. The apparatus of claim 12 wherein the generated 3D content is static.

22. The apparatus of claim 10 wherein the generated 3D content is dynamic.

23. A system comprising:
a user device configured for:
capturing 2D content from a video game; and
transmitting the 2D content to a cloud device;
the cloud device configured for:
generating 3D content from the 2D content; and
sharing the 3D content.

24. The system of claim 23 wherein the cloud device is further configured for extracting 2D frames from the 2D content.

25. The system of claim 24 wherein the 2D frames comprise a plurality of images of an object or a scene from a plurality of angles.

26. The system of claim 23 wherein the user device is further configured for encoding the 2D content.

27. The system of claim 23 wherein the cloud device is further configured for implementing training data preparation, including reconstructing 3D structures from a series of 2D images taken from different perspectives.

28. The system of claim 27 wherein the cloud device is further configured for training a model using the trained data preparation.

29. The system of claim 28 wherein generating the 3D content from the 2D content uses the trained model.

30. The system of claim 29 wherein generating the 3D content utilizes point-based representations including Gaussian splats.

31. The system of claim 23 wherein the user device is further configured for displaying the 3D content including enabling interaction with the 3D content.

32. The system of claim 23 wherein the generated 3D content is static.

33. The system of claim 23 wherein the generated 3D content is dynamic.
